(19) United States
(12) Patent Application Publication
(10) Pub. No.: US 2020/0079566 A1
(43) Pub. Date: Mar. 12, 2020

(54) FILM FOR EASY-OPEN PACKAGING

(71) Applicant: AMCOR FLEXIBLES BURGDORF GMBH, Burgdorf (CH)

(72) Inventor: Martin ROTHENBÜHLER, Emmental (CH)

(21) Appl. No.: 16/610,313

(22) PCT Filed: May 3, 2018
(86) PCT No.: PCT/EP2018/061420

§ 371 Date: Nov. 1, 2019

(30) Foreign Application Priority Data
May 3, 2017 (CH) 17020190.9

(51) Int. Cl. B65D 75/58; B65D 65/22; B31B 70/26; B31B 70/64

(52) U.S. Cl. CPC B65D 75/5833; B65D 65/22; B31B 2150/00; B31B 70/64; B31B 70/26

(57) ABSTRACT

Film strip (1) for wrapping food or pharma products, packaging made thereof and a process for manufacturing said packaging. The film strip (1) is made of a flexible and foldable composite film comprising a continuous protection layer (70) and on one outermost side of the composite film at least partly a sealing layer (11) which forms at least on one end part (12, 14) a sealing band (5, 6), wherein one sealing band (5) is further spaced apart from the corresponding end face (15) than the other one (6). The composite film comprises further at least one polymer layer (11, 70, 72) having at least one weakening line (40), wherein the weakening line/s start/s from the end face (15) whose sealing band (5) is further spaced apart from the corresponding end face (15) than the other sealing band (6), the weakening line/s extend/s further through said end part (14) and along the whole longitudinal extension B1 of the adjacent sealing band (5) or through the polymer film (11, 70, 72) lying above the whole longitudinal extension B1 of the sealing band (5) and further extend/s continuously into at least a part of said polymer layer (11, 70, 72) adjacent to said area of or above said sealing band (5) in the direction of the first end face (13).

The invention relates to a film strip for wrapping food or pharma products, the film strip has a width W between its two parallel longitudinal sides and a length L between its two opposite lying end faces, wherein adjacent to each end face the film strip features an end part, the film strip is made of a flexible and foldable composite film comprising a continuous protection layer and on one outermost side of the composite film at least partly a sealing layer which forms at least on one end part of the film strip a sealing band between the longitudinal sides of the film strip, wherein each sealing band has a predefined length, wherein one sealing band is further spaced apart from the corresponding end face than the other one if two sealing bands are provided, and in case of only one sealing band, it is spaced apart from the corresponding end face.

The invention further relates to a packaging made of an inventive film strip, wherein a first and a second end part of the film strip are joined together by a sealing means in a junction or sealing area defined by the sealing band/s with one of said end parts overlying the other one, wherein the overlying end part defines the outer surface of said packaging, wherein the second end part comprising the sealing band that is further spaced apart from the corresponding end face than the other one, or in case that only one sealing band is provided, the second end part comprising said sealing band lies on top of the other first end part, wherein the area between the end face of the second end part and the adjacent sealing band of the outer lying second end part defines a junction-free zone providing a tear tab, wherein the sealing area comprises a zone providing a strong sealing strength and a weak zone providing a lower sealing strength compared to that of the strong zone.

The invention also relates to a method for manufacturing said packaging.

Flexible film strips are widely used for wrapping items such as food or pharma products. Various problems associated with opening such a packaging are well known and various attempts have been made to overcome such problems.

Some embodiments use a tear strip that is separately applied to a wrapping film. The application of a separate tear strip increases the complexity of the packaging and increases the manufacturing costs thereof. A further drawback of using a separate tear strip concerns the risk of swallowing small packaging pieces when children consume the packaged product.

Therefore, there is a need to provide an easy-open packaging film for wrapping food or pharma products that consists of one single piece. A further object of present invention relates to the disclosure of an easy-open packaging for a hermetically sealed packaging.

U.S. Pat. No. 5,184,771A discloses a hermetic tubular pouch wrapping comprising two strip-like edge zones of the wrap material that are joined together by sealing, and two incisions are present in at least one of the two edge zones, wherein the wrap material forms a grip tab between said two incisions by means of which a tear-open region is pulled off when the wrapping is being opened. The incisions extend perpendicularly to this edge zone over the entire fold produced by the upper edge zone that is longer than the lower edge zone and at its free wrap-material edge shows said fold that is fixed in place by cold sealing. The incisions further extend into the connection area at the upper edge zone. The wrap material outside of said edge zone is free of any weakening line or material weakening.

U.S. Pat. No. 5,470,015A describes a tubular pouch for piece goods comprising a wrap formed by a planar, foldable wrapping material of which two edge strips are sealed together in a junction area with one of said edge strips overlying the other of said edge strips and defining an outer surface of said wrap, wherein a junction-free zone is present in said one of said edge strips. This junction-free zone is provided with a U-shaped perforation forming the beginning of a strip-shaped tear-open strip. Said U-shaped perforation includes a base and two legs pointing toward the junction area and ending in said junction area, wherein at least one portion of the U-shaped perforation is located outside of the junction area and a segment of said one of the edge strips, that is enclosed along three sides by said U-shaped perforation and is located within said junction-free zone, is externally folded onto the outer surface of said wrap atop said junction area.

WO 2016/131742A1 discloses a flexible laminate for forming a reclosable packaging container comprising a built-in opening and reclose feature, said laminate comprising an inner structure and an outer structure, adhesively joined face-to-face, the outer structure forming the outer surface of the container and the inner structure forming the inner surface of the container, the outer structure comprising an outer flap portion delimited by a scoring line through the outer structure, and an inner structure comprising an inner flap portion delimited by a scoring line through the inner structure, the inner score line and the outer score line creating an opening into the container when the flap portions are peeled back, a marginal region of the outer flap portion extending beyond an edge of the inner flap portion and overlying an underlying surface of the inner structure, the inner and outer flap portions being joined in a second adhesive region and the first adhesive region being disposed between the marginal region of the outer flap portion and the underlying surface of the inner structure for attaching and re-attaching, in use, the outer flap portion to the underlying surface, wherein the bond/peel strength of the first adhesive is smaller than the bond/peel strength of the second adhesive, the first adhesive being permanently tacky and covering the entire surface of either the inner structure or the outer structure, said first adhesive being patterned covered by one or more crosslinker(s), transforming a part of the layer thickness of said first adhesive into the second adhesive and creating patterns of first adhesive region and second adhesive region, said second adhesive of the second adhesive region having a higher degree of crosslinking than said first adhesive of the first adhesive region.

One disadvantage of the packaging films according to U.S. Pat. No. 5,148,771A or U.S. Pat. No. 5,470,015A may arise if the tearing direction is not in line with the incisions, i.e. when the tearing force is applied obliquely to the direction of the incisions. In this case, the opening direction of the packaging is difficult to control.

According to present invention there is provided a film strip for wrapping food or pharma products having the features of claim 1.

The film strip has a width W between its two parallel longitudinal sides and a length L between its two opposite lying end faces, wherein adjacent to each end face the film strip features an end part. The film strip is made of a flexible and foldable composite film comprising a continuous protection layer and on one outermost side of the composite film at least partly a sealing layer which forms at least on one end part of the film strip a sealing band between the longitudinal sides of the film strip. Each sealing band has a predefined length, wherein one sealing band is further spaced apart from the corresponding end face than the other one if two sealing bands are provided and in case of only one sealing band, it is spaced apart from the corresponding end face.

The predefined length of a sealing band means a predefined average length measured parallel to the longitudinal sides of the film strip.

The space between the end face and the adjacent sealing band is an end zone. The length of each end part is defined by the longitudinal extension between its end face and the border of the adjacent sealing band furthest spaced apart from said end face. Consequently, each end part comprises the end zone and the adjacent sealing band.

The composite film comprises at least one polymer layer having at least one weakening line, wherein the weakening line/s start/s from the end face whose sealing band is further spaced apart from the corresponding end face than the other one, or in case where only one sealing band is provided, each weakening line starts from the end face of the end part comprising said sealing band, extends further through the end zone of said end part and along the whole longitudinal extension B1 of the adjacent sealing band or through the polymer film lying above the whole longitudinal extension B1 of the sealing band and further extend/s continuously into at least a part of said polymer layer adjacent to said area of or above said sealing band in the direction of the first end face.

Further preferred embodiments of the inventive film strip are described in the claims directly or indirectly depending on claim 1.

Because each weakening line of the polymer film comprising said weakening line/s extends through the whole longitudinal extension of the polymer film laying above the sealing band, or extends through the whole longitudinal extension of the sealing band, and further extends into at least a part of said polymer film adjacent to said sealing band in the direction of the opposite sealing band, the tear direction is controllable not only till the sealing band, but for a much longer tearing length. On the other hand, the continuous protection layer accomplishes the required barrier against odour, oxygen, moisture or other gas or liquid permeation through the wrapping film.

A preferred inventive film strip has only one weakening line. This improves the impermeability of a packaging made of said film strip.

The continuous protection layer may be accomplished by any continuous layer of the composite film not featuring any weakening line. The protection layer may be a metallic film, a polymer film, a polymer covered paper layer or a metallised polymer film. The continuous protection layer may also be accomplished by the innermost sealing layer if it is a continuous layer covering one face of the whole film strip. The continuous protection layer is in any case a layer in addition to the polymer layer comprising the weakening line/s. A preferred composite film comprises an outer continuous protection layer and an innermost sealing layer as well as a polymer layer featuring the weakening line/s.

The weakening line/s is/are preferably perforated line/s. In a further preferred embodiment, the polymer layer having the weakening lines may feature two non-intersecting weakening lines.

In a further preferred embodiment the sealing bands are arranged perpendicular to the longitudinal sides of the film strip.

The sealing layer may consist of the sealing band/s only. On the other hand, the sealing band/s may be part of a continuous sealing layer and hence just identify an area of the sealing layer that is designed to be the sealing zone when sealing two end parts of the film strip together to manufacture the wrapping.

The at least one polymer film featuring the weakening line/s is preferably an oriented polymer film in order to give a better guidance of the separation direction of the film strip along the weakening line/s and the further fracture of the film strip. Such an oriented polymer film having the weakening line/s is preferably made of polyester, polyethylene 2,5-furandicarboxylate (PEF), polyethylene (PE), polypropylene (PP), polyamide (PA) or polymer-coated paper. A preferred polyester is polyethylene terephthalate (PET).

In a preferred embodiment of the inventive film strip, each weakening line is a straight line extending from the end face whose sealing band is further spaced apart from the corresponding end face and runs in an acute angle to said end face.

In a further preferred embodiment of the inventive film strip, each weakening line is a straight line running perpendicularly to the end face whose sealing band is further spaced apart from the corresponding end face in an area between said end face and said sealing band and extends further in a continuous straight line arranged in an acute angle to said end face.

The extension of the weakening line in an acute angle to the end face allows a better customisation to the packaged good and to the customer needs and habits as e.g. the tearing direction normally used when holding the packaged good in one hand and using the other hand to open the packaging and hence allows a person to tear the tear band with the most effective application of force. In particular, a weakening line running in an acute angle to the end face is preferred in conjunction with a polymer layer having only one single weakening line.

In a preferred embodiment, the sealing layer may comprise a sealing area having at least two zones with different sealing performance wherein one zone providing a strong sealing strength and the other one is a weak zone providing a low sealing strength, wherein the film strip features at least in the area comprising said weak zone at least one weakening line. The weak zone has to be suitable for peeling when two end parts of the film strip are sealed together.

A high tear strength means that sealed end parts of the film strip may not be separated without destroying or tearing the composite film. A low tear strength means that sealed end parts of the film strip are separable by a peeling process.

The weakening line may be a continuous cut through one or several layers of the composite film, except through the protection layer, or the weakening line may be a perforated line through said layers. The cut or perforation may be done mechanically, chemically or by using a laser.

The polymer layer comprising the weakening line/s may be a composite film having two or more polymer layers.

The weakening lines preferably encompass only the layer/s of the flexible composite film that have a dominant tear strength in regard to the whole composite film in order to give a guidance of the direction of separation of the film strip along the weakening line.

Possible preferred layer compositions are PET/PE, PETP/Al/PE wherein PETP means polyethylene terephthalate polyester, Al means a layer of aluminium and PE means polyethylene, PET/OPP wherein OPP means oriented polypropylen, PET/Al/OPA/PE wherein OPA means oriented polyamide, Al/OPP or Al/PET/sealing varnish.

The sealing layer providing the weak zone may consist of or may be covered with a sealant varnish suitable for peeling. The sealing layer may also be made of a sealant varnish having different thicknesses in the zone providing the strong sealing strength and the weak zone.

The weak zone of the sealing layer may also comprise a cohesively breaking sealing layer.

Present invention also relates to a packaging made of the inventive film strip having the features of claim 11.

A first and a second end part of the inventive film strip are joined together by a sealing means in a junction or sealing area defined by the sealing band/s. One of said end parts overlies the other end part and hence defines the outer surface of the packaging. The second end part comprising the sealing band that is further spaced apart from the corresponding end face than the other one, or in case that only one sealing band is provided, the second end part comprising said sealing band lies on top of the other first end part, wherein the area between the end face of the second end part and the adjacent sealing band of the outer lying second end part defines a junction-free zone providing a tear tab. The sealing area comprises a zone providing a strong sealing strength and a weak zone providing a lower sealing strength compared to that of the strong zone. The weakening line/s of said polymer layer start/s from the end face of the second end part, extend/s continuously through the junction-free zone and through the whole longitudinal extension of the weak zone and further extend/s into at least a part of said polymer layer adjacent to said sealing zone lying between the first and second end parts.

Further preferred embodiments of the inventive packaging are described in the claims directly or indirectly depending on claim 11.

The sealing area comprises a zone providing a strong sealing strength and a weak zone providing a lower sealing strength. A strong or high tear strength means that sealed end parts may not be separated without destroying or tearing the composite film. A weak or low tear strength means that sealed end parts of the film strip are separable by a peeling process.

The polymer film comprising the weakening line/s of the second outer lying end part of the film strip comprises weakening line/s starting from the outer edge or outer face of the tear tab of the second end part, passing the tear tab, extending through the weak zone of the sealing area and running further into the composite film adjacent to the weak zone in the direction of the first end part.

In a further preferred embodiment the packaging or wrapping comprises a fin seal showing an inside-inside seal, wherein the inner layer of the flexible composite film directed to the inside of the packaging comprises at least partly the sealing layer and in that the first end part of said film strip is folded back providing a sealing surface made of the sealing layer, the second end part of the film strip is sealed onto the folded back part of the first end part, wherein the fin seal comprises at least one weak zone having a low sealing strength, wherein the second end part of the composite film extends over the fin seal and the folded back part of the first end part to form the tear tab.

In an even further preferred embodiment the packaging or wrapping comprises a lap seal showing an inside-outside seal, wherein the inner layer of the flexible composite film directed to the inside of the packaging comprises at least partly the sealing layer, and in that the second end part of the film strip comprises said sealing layer and is sealed onto the outside of the first end part of the film strip, wherein the lap seal comprises at least one weak zone having a low sealing strength, wherein the second end part of the film strip extends over the lap seal to form the tear tab.

If the packaging has only one single weakening line, the sealing area preferably features on one side of the weakening line the zone having a strong sealing strength and on the other side of the weakening line the weak sealing zone.

If the packaging has two non-intersecting weakening lines, the sealing area under the tearing strip between the two weakening lines preferably features the weak sealing zone and the sealing area outside said weak sealing zone is the zone having a strong sealing strength.

The packaging according to the invention is especially suitable for hermetically packing food or pharmaceutical products.

Present invention also relates to a method for manufacturing a packaging as described above. The method comprises the following steps:
(a) providing a film strip according to present invention having two opposite end parts,
(b) folding a second end part of the film strip over a first end part of the film strip in a manner that the distance between the outer end face of the second end part to the sealing area is greater than the distance between the outer end face of the first end part to the sealing area, and at least a part of the sealing area comprises a weak sealing zone providing a sealing strength that allows the two sealed end parts to be peeled from one another, and that said sealing area comprises the at least one weakening line, the weakening line running continuously from the end face of the second end part of the film strip through the whole longitudinal extension of the week zone of the sealing area, and into at least a part of the film strip adjacent to said sealing zone in the direction of the first end part.
(c) sealing the first and second end parts together wherein the free end face of the second end part of the film strip extends over the sealing area for providing a tear tab.

In a preferred embodiment of the method, the sealing area comprises a zone providing a strong sealing strength and a weak zone providing a lower sealing strength, wherein the different sealing strengths of the strong and weak sealing zones is created by the application of different sealing parameters, wherein the sealing zone having the higher sealing strength is made by applying a higher sealing temperature and/or a higher sealing pressure and/or a longer sealing time compared to the sealing parameters used for the sealing zone having weak sealing properties suitable for opening the packaging by peeling the second from the first end part of the film strip in the weak sealing zone.

The sealing zones having a different sealing strength may also be realized by modifying differently the surface textures of the sealing surface in the weak zone and in the zone providing the strong sealing strength.

The invention will now be described by way of examples and with reference to the accompanying drawings in which:

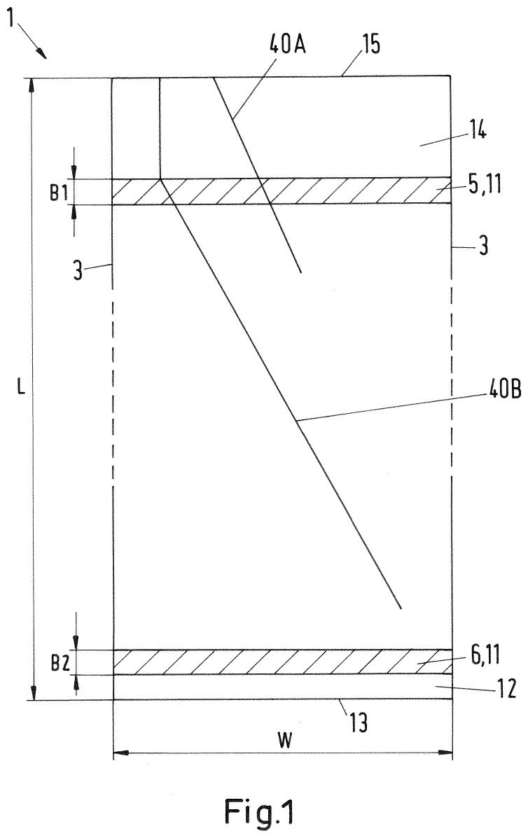

FIG. 1 shows schematically a top view onto an inventive film strip;

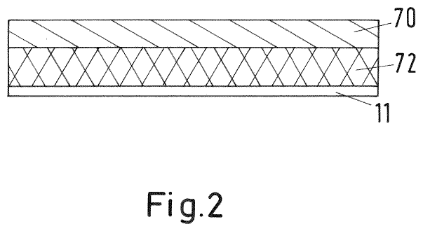

FIG. 2 shows schematically a cross section through a composite film of the inventive film strip;

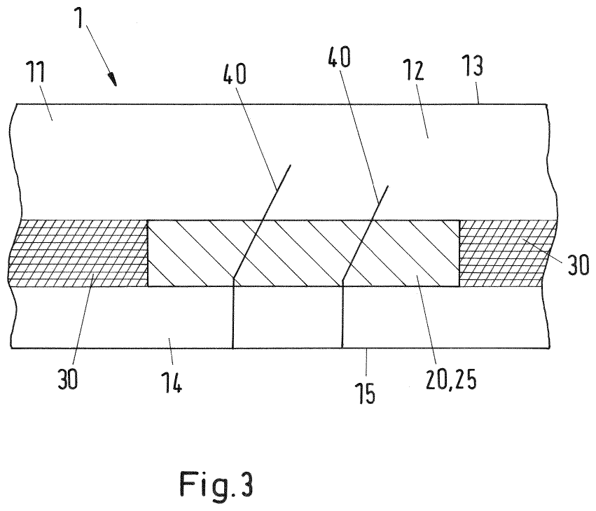

FIG. 3 shows schematically a topview onto the junction or sealing zone of an inventive packaging;

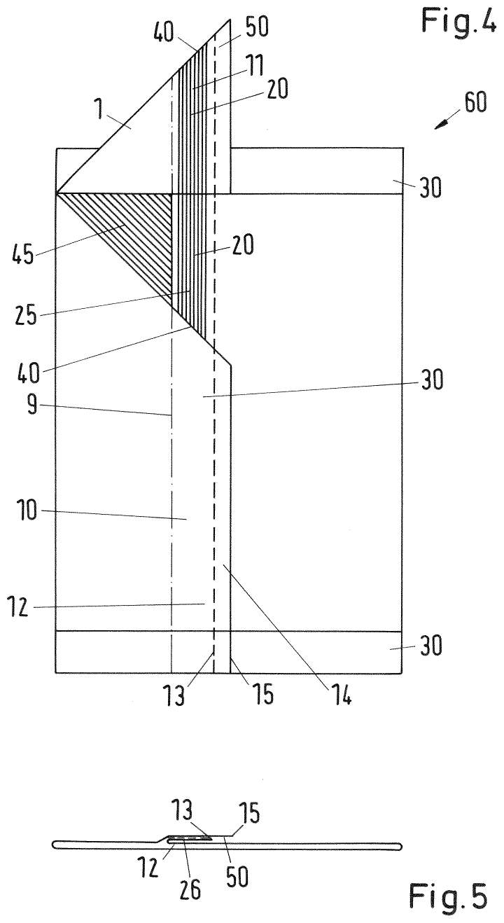

FIG. 4 shows schematically a topview onto an opened packaging having a fin seal between the sealed opposite end parts of a film strip;

FIG. 5 shows a cross-section through the packaging shown in FIG. 4;

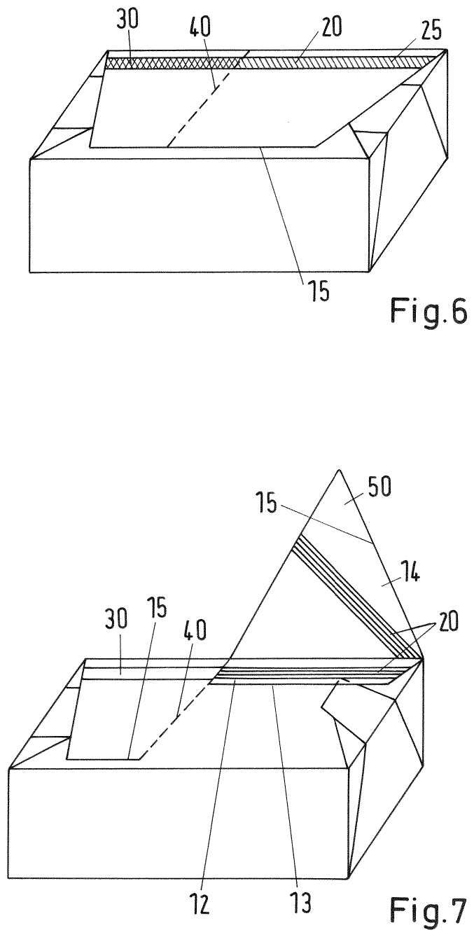

FIG. 6 is a perspective view of the packaging shown in FIGS. 4 and 5 in a closed state enclosing a packaged product;

FIG. 7 is a perspective view of the packaging shown in FIGS. 4 and 5 in an open state;

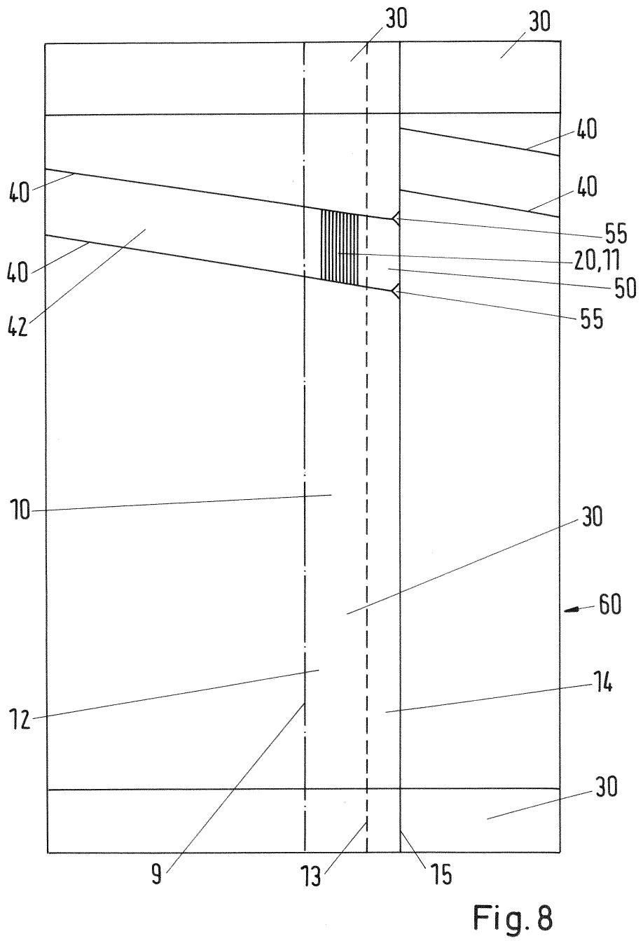

FIG. 8 shows schematically a topview of a packaging having a fin seal between the sealed opposed end parts of a film strip having two parallel weakening lines surrounding the packaging to the full extent.

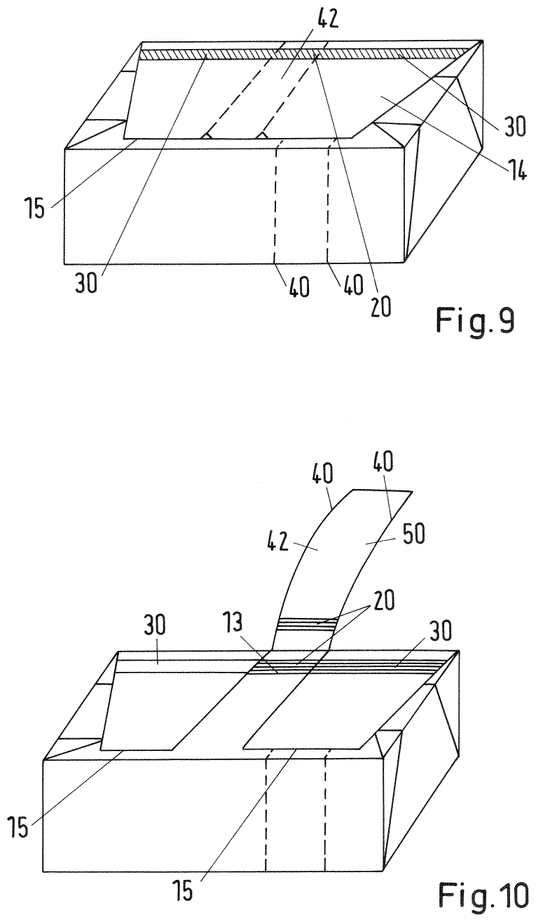

FIG. 9 is a perspective view of the packaging shown in FIG. 8 in a closed state enclosing a packaged product;

FIG. 10 is a perspective view of the packaging shown in FIG. 8 in a partially open state;

FIG. 11 shows schematically a topview onto a closed packaging having a lap seal between the sealed opposed end parts of an inventive film strip;

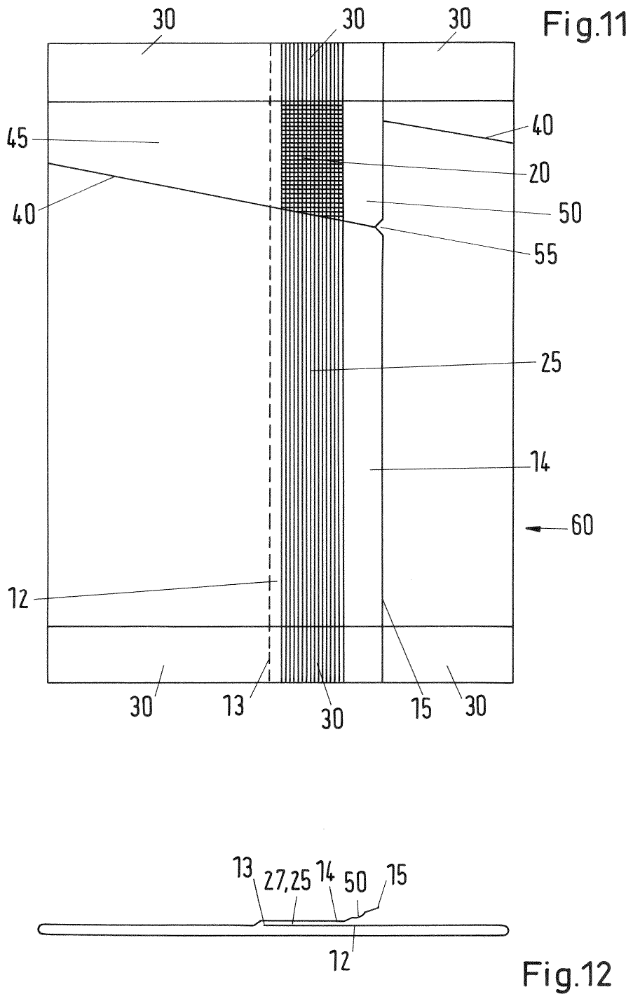

FIG. 12 shows a cross-section through the packaging shown in FIG. 11.

FIG. 1 shows a top view onto a film strip 1 having a width W between its two parallel longitudinal sides 3 and a length L between its two opposite lying end faces 13, 15, wherein adjacent to each end face 13, 15 the film strip 1 features an end part 12, 14. Each end part 12, 14 of the film strip 1 has a sealing band 5, 6 between the longitudinal sides 3 of the film strip 1, wherein the sealing layer 11 in FIG. 1 is only present in said sealing bands 5, 6. Each sealing band 5, 6 has a predefined length B1, B2, wherein the sealing band 5 is further spaced apart from the corresponding end face 15 than the other one 6. The film strip 1 shown in FIG. 1 has at least two transparent polymer layers on top of the sealing bands 5, 6, thus allowing to see the polymer layer having two weakening lines 40A, 40B. The polymer layer having the weakening lines 40A, 40B may be the outermost layer lying opposite to the sealing layer 11, wherein the continuous protection layer is an intermediate layer. On the other hand, the polymer layer having the weakening lines may be an intermediate layer and the continuous protection layer may be the outermost layer lying opposite to the sealing layer.

One weakening line 40A runs in a straight line at an acute angle to the end face 15 starting from the outer edge or end face 15 of the end part 14, extends through the end part 14 including the longitudinal extension B1 of the sealing band 5 and further extends into a part of said polymer layer of the film strip 1 in the direction of the second sealing band 6. A second weakening line 40B first runs perpendicular to the end face 15 in an area between the end face 15 and the sealing band 5 and then runs above the longitudinal extension of the sealing band 5 and further into the polymer film of the film strip 1 lying between the two opposite sealing bands 5, 6 in a straight line having an acute angle with said end face 15.

FIG. 2 shows schematically a cross section of a preferred composite film used for the inventive film strip 1. The composite film has a sealing layer 11 and an outer protection layer 70 as well as an intermediate polymer layer comprising the weakening line/s. Alternatively, layer 70 may comprise the weakening line/s and layer 72 may be the continuous protection layer. As a further alternative, the sealing layer may be a continuous protection layer and the outermost layer and/or the intermediate layer may comprise the weakening line/s.

FIG. 3 shows a topview onto a junction or sealing zone 25 of a flexible film strip 1 having a sealing zone 20, called weak zone 20, providing a weak sealing strength and a sealing zone 30 providing a strong sealing strength. The film strip 1 has two opposite lying end parts 12, 14 and shows two parallel weakening lines 40 starting from the outer edge 15 of the second end part 14, passing the weak zone 20 and continue in the direction of the first end part 12 of the film strip 1.

FIG. 4 shows a topview onto an opened packaging 60 made of a flexible film strip 1 having two opposite lying end parts 12, 14. The sealing layer 11 comprises a sealing area 25 having two zones 20, 30 with different sealing performance wherein the zone 30 provides a strong sealing strength and the other one is a weak zone 20 providing a low sealing strength. The package 60 presented in FIG. 4 has a fin seal 26 showing an inside-inside seal, wherein the inner layer of the flexible film strip 1 directed to the inside of the packaging 60 comprises a sealing layer 11. The first end part 12 of said film strip 1 is folded back providing a fold edge 9 and a folded back part 10 that serves as sealing surface made of the sealing layer 11. The first and second end parts 12, 14 of the film strip 1 form an overlapping zone comprising a sealing area 25, 26. The second end part 14 of the film strip 1 is sealed onto the folded back part 10 of the first end part 12. The second end part 14 of the film strip 1 extends over the sealing area 25 and the folded back part 10 of the first end part 12, i.e. the outer edge 15 of the second end part 14 of the film strip 1 overlaps the outer edge 13 of the first end part 12 and the sealing area 25, 26 to form a tear tab 50. The packaging shown in FIG. 4 features a single weakening line 40 wherein said weakening line 40 is in the form of a straight line enclosing an acute angle with the outer edge 15 of the second end part 14 of the film strip 1. The weakening line 40 extends from the outer edge 15 of the second end part 14 through the weak zone 20 of the sealing area 25, 26 into the flexible film strip 1 adjacent to the weak zone 20, i.e. into the part of the film strip 1 adjacent to the weak zone 20 lying opposite to the second end face 15. Consequently, the second end part 14 teared back along the weakening line 40 has the form of a triangle and uncovers an access zone 45 for a packaged product.

FIG. 5 shows a cross-section through the packaging presented in FIG. 4. The packaging 60 comprises a fin seal 26 and the first end part 12 is folded back. The outer edge 15 of the second end part 14 (upper end) extends over the outer edge 13 of the folded back portion 10 of the first end part 12 and provides a tear tab 50. The part of the second end part 14 overlapping the folded back part 10 of the first end part 12 defines the sealing area 25, 26. FIG. 5 shows clearly that the distance between the outer lying edge 15 of the second end part 14 to the sealing area 25 is greater than the distance between the inner lying outer edge 13 of the first end part 12 to the sealing area 25, 26.

FIG. 6 is a perspective view of the packaging shown in FIGS. 4 and 5 in a closed state enclosing a packaged product. The weakening line 40 starts at the outer edge 15 of the second end part 14 (upper end of the film strip 1) and runs further in the polymer layer having the weakening line 40 to the end of the upper surface of the packaging 60. The sealing area 25 features on the left of the weakening line a zone 30 having a strong sealing strength. On the right side of the weakening line 40 the sealing area 25 consists of a zone 20 having a weak sealing strength.

FIG. 7 is a perspective view of the packaging shown in FIGS. 4 and 5 in an open state, i.e. after tearing off the second end part 14 of the film strip 1 along the weakening line 40. The teared off part of the second end part 14 reveals the outer edge 13 of the first end part 12 of the film strip 1. FIG. 7 also shows the large extension of the second end part 14 from the outer edge 13 of the first end part 12 thus creating a large tear tab 50.

FIG. 8 shows a topview onto a packaging 60 made of a flexible film strip 1 having two opposite lying end parts 12, 14. The sealing layer 11 comprises a sealing area 25 having two zones 20, 30 with different sealing performance wherein the zone 30 provides a strong sealing strength and weak zone 20 provides a low sealing strength. The package shown in FIG. 8 has a fin seal 26 showing an inside-inside seal, wherein the inner layer of the flexible film strip 1 directed to the inside of the packaging 60 comprises a sealing layer 11. The first end part 12 of said film strip 1 is folded back providing a fold edge 9 and a folded back part 10 that serves as sealing surface made of the sealing layer 11. The second end part 14 of the film strip 1 extends over the sealed folded back part 10 of the first end part 12 forming a free lying end of the second end part 14 forming a tear tab 50. The packaging of FIG. 8 features two parallel weakening lines 40 surrounding the whole cross-section of the packaging, wherein the weakening lines 40 enclose an acute angle with the outer edge 15 of the second end part 14 of the film strip 1. The two weakening lines 40 enclose a tear strip 42. The weakening lines 40 extends from the outer edge 15 of the second end part 14 through the weak zone 20 of the sealing area 25, 26 and end in the first end part 12 of the film strip 1. The outer edge 15 of the second end part 14 features at the start of each weakening line 40 a notch 55 as opening aid. The packaging shown in FIG. 8 allows a full transverse side as access zone 45 for a packaged product, e.g. a chocolate bar wrapped by said film strip 1 in a direction parallel to the outer edges 13, 15 of the end parts 12, 14.

FIG. 9 is a perspective view of the packaging 60 shown in FIG. 8 in a closed state enclosing a packaged product. The weakening lines 40 start at the outer edge 15 of the second end part 14 (upper end of the film strip 1) and surround the whole cross-section of the packaging.

FIG. 10 is a perspective view of the packaging shown in FIG. 8 in a partially open state, i.e. after tearing off partly the strip 42 between the two weakening lines 40. The teared off strip 42 of the second end part 14 reveals the outer edge 13 of the first end part 12 of the film strip 1. FIG. 8 also shows the large extension of the second end part 14 from the outer edge 13 of the first end part 12 thus creating a large tear tab 50.

FIG. 11 shows schematically a topview onto a closed packaging 60 having a lap seal 27 between the two opposite lying end parts 12, 14 of a film strip 1. The sealing is performed between the inner sealing layer of the second end part 14 and the outer surface of the first end part 12, wherein the second end part 14 of the film strip 1 overlaps the outer surface of the first end part 12 of the film strip 1. The sealing area 25, 27 between the two opposite lying end parts 12, 14 has two zones 20, 30 with different sealing performance wherein the one zone 30 provides a strong sealing strength and the other one is a weak zone 20 providing a low sealing strength. The second end part 14 of the film strip 1 extends over the sealing area 25, 27, i.e. the outer edge 15 of the second end part 14 of the film strip 1 overlaps the outer edge 13 of the first end part 12 and the sealing area 25, 27 to form a tear tab 50. The packaging shown in FIG. 11 features a single weakening line 40 surrounding the whole cross-section of the packaging 60. The weakening line 40 extends from a notch 55 as opening aid at the outer edge 15 of the second end part 14 and runs through the weak zone 20 of the sealing area 25 and surrounds the whole cross-section of the packaging 60 to end in the first end part 12 of the film strip 1. Consequently, the packaging 60 shown in FIG. 11 allows a full transverse side as access zone 45 for a packaged product, e.g. a chocolate bar wrapped by said film strip 1 in a direction parallel to the outer edges 13, 15 of the end parts 12, 14.

FIG. 12 shows a cross-section trough the packaging shown in FIG. 11. The package comprises a lap seal 27. The outer edge 15 of the second end part 14 (upper end) extends over the outer edge 13 of the first end part 12 and the sealing area (25, 27) and provides a tear tab 50.

The sealing strength of a number of different layer structures of the composite film has been measured. The test results are presented in Table 1. The composite structure shown in table 1 indicate the layer structure from outside to the inside, i.e. to the sealing layer. Furthermore, the thickness of the corresponding layer has been indicated after the material. The corresponding composite films have been folded and the two end parts of the composite film have been sealed together. Fin and lap seals have been tested. The sealing bar had a predefined temperature and has been pressed onto the sealing area of the composite film with a predefined pressure for a predefined duration (sealing time). The tests have been performed by heating only one side of the sealing means, i.e. the sealing bar, if in table 1 the heated sides is indicated with “1”. If in table 1 the heated sides is indicated with “2”, the counterpart of the sealing bar has been heated too. Tests have been performed with a sealing bar having a flat sealing surface as well as with a sealing bar having a corrugated sealing surface. The sealing strength has been measured by measuring the peel strength.

Only test no. 11 has been done using a lap seal showing an inside-outside seal. Test numbers 1 to 10 and 12 to 16 concern a fin seal showing an inside-inside seal.

TABLE 1

| | | Sealing | Sealing | sealing | heated | sealing bar | Seal/peel | |
|---|---|---|---|---|---|---|---|---|
| Test | composite structure: | temperature | pressure | time | sides | profile | strength | subject of the Test |
| no. | [ ] | [° C.] | [N/cm2] | [sec] | [ ] | [ ] | [N/15 mm] | [ ] |
| 1 | Alu9μ/PET12μ/sealing varnish 1 (3.2 g/m2) | 120 | 50 | 0.5 | 1 | flat | 1.21 | weak seal |
| 2 | Alu9μ/PET12μ/sealing varnish 1 (3.2 g/m2) | 150 | 50 | 0.5 | 2 | flat | 0.92 | weak seal |
| 3 | OPP30μ/PE30μ/sealing varnish 2 (2.0 g/m2) | 120 | 50 | 0.5 | 1 | flat | 2.70 | weak seal |
| 4 | PET12μ/PE40μ selaing varnish 3 (1.8 g/m2) | 120 | 50 | 0.5 | 1 | flat | 4.17 | weak seal |
| 5 | PET12μ/PE40μ | 120 | 50 | 0.5 | 1 | flat | 36.03 | strong seal |
| 6 | PET12/HDPE50 peelable | 150 | 50 | 0.5 | 2 | flat | 6.19 | weak seal |
| 7 | PET12/HDPE50 peelable | 150 | 50 | 0.5 | 2 | corrugated | 9.65 | strong seal |
| 8 | PET12/HDPE50 peelable | 150 | 50 | 1 | 2 | corrugated | 9.25 | strong seal |
| 9 | PET12/HDPE50 peelable | 190 | 50 | 1 | 2 | corrugated | 19.97 | strong seal |
| 10 | OPP30μ/Met.OPP35μ/sealing varnish 2 (2.0 g/m2) | 150 | 50 | 0.5 | 2 | flat | 3.70 | weak seal |
| 11 | OPP30μ/Met.OPP35μ/sealing varnish 2 (2.0 g/m2) | 120 | 50 | 0.5 | 2 | flat | 1.73 | weak seal |
| 12 | OPP30μ/Met.OPP35μ | 150 | 50 | 0.5 | 2 | flat | 5.11 | strong seal |
| 13 | Alu7μ/sealable PET23 | 150 | 50 | 0.5 | 2 | flat | 13.27 | strong seal |
| 14 | Alu7μ/sealable PET23/sealing varnish 2 (2.8 g/m2) | 150 | 50 | 0.5 | 2 | flat | 2.84 | weak seal |
| 15 | Alu7μ/sealable PET23/sealing varnish 2 (2.8 g/m2) | 120 | 50 | 0.5 | 1 | flat | 3.01 | weak seal |
| 16 | Alu7μ/sealable PET23/sealing varnish 1 (3.2 g/m2) | 120 | 50 | 0.5 | 1 | flat | 2.46 | weak seal |

1. Film strip (1) for wrapping food or pharma products, the film strip (1) has a width W between its two parallel longitudinal sides (3) and a length L between its two opposite lying end faces (13, 15) wherein adjacent to each end face (13, 15) the film strip (1) features an end part (12, 14), the film strip (1) is made of a flexible and foldable composite film comprising a continuous protection layer (70) and on one outermost side of the composite film at least partly a sealing layer (11) which forms at least on one end part (12, 14) of the film strip (1) a sealing band (5, 6) between the longitudinal sides (3) of the film strip (1), wherein each sealing band (5, 6) has a predefined length (B1, B2), wherein one sealing band (5) is further spaced apart from the corresponding end face (15) than the other one (6) if two sealing bands are provided and in case of only one sealing band, it is spaced apart from the corresponding end face (15),
characterised in that
the composite film comprises at least one polymer layer (11, 70, 72) having at least one weakening line (40), wherein the weakening line/s start/s from the end face (15) whose sealing band (5) is further spaced apart from the corresponding end face (15) than the other one (6), or in case where only one sealing band is provided, each weakening line (40) starts from the end face (15) of the end part (14) comprising said sealing band (5), extends further through said end part (14) and along the whole longitudinal extension B1 of the adjacent sealing band (5) or through the polymer film (70, 72) lying above the whole longitudinal extension B1 of the sealing band (5) and further extend/s continuously into at least a part of said polymer layer (11, 70, 72) adjacent to said area of or above said sealing band (5) in the direction of the first end face (13).

2. Film strip (1) according to claim 1, characterised in that each weakening line (40) is a straight line extending from the end face (15) whose adjacent sealing band (5) is further spaced apart from the corresponding end face (15) than the other sealing band (6) from the other end face (13), wherein the weakening line includes an acute angle to said end face (15).

3. Film strip (1) according to claim 1, characterised in that each weakening line (40) starts from the end face (15) whose adjacent sealing band (5) is further spaced apart from the corresponding end face (15) than the other sealing band (6) from the other end face (13), wherein the weakening line (40) extends perpendicularly to the end face (15) in an area between said end face (15) and said sealing band (5) and extends further in a continuous straight line arranged in an acute angle to said end face (15).

4. Film strip (1) according to claim 1, characterised in that the at least one polymer layer (11, 72) featuring the weakening line/s (40) is an oriented polymer film.

5. Film strip (1) according to claim 1, characterised in that the polymer film (11, 72) featuring the weakening line/s (40) is made of polyester, polyethylene 2,5-furandicarboxylate (PEF), polyethylene (PE), polypropylene (PP), polyamide (PA) or polymer-coated paper.

6. Film strip according to claim 1, characterised in that at least one sealing band (5, 6) has at least two sealing zones (20, 30) with different sealing performance, wherein one zone (30) providing a strong sealing strength and the other one is a weak zone (20) providing a low sealing strength.

7. Film strip according to claim 6, characterised in that the weak zone (20) is covered with a sealant varnish suitable for peeling.

8. Film strip according to claim 6, characterised in that the weak zone (20) of the sealing layer (11) is a cohesively breaking sealing layer.

9. Film strip according to claim 6, characterised in that the sealing band/s is/are made of a sealant varnish having different thicknesses in the zone (30) providing the strong sealing strength and in the weak zone/s (20).

10. Film strip according to claim 6, characterised in that the weakening line/s extend through at least one of the weak zones (20) of the sealing band (5).

11. Packaging made of a film strip (1) according to claim 1 for wrapping a food or pharma product, a first and a second end part (12, 14) of the film strip (1) are joined together by a sealing means in a junction or sealing area (25) defined by the sealing band/s (5, 6) with one of said end parts (14) overlying the other one (12) of said end parts (12, 14) defining the outer surface of said packaging, wherein the second end part (14) comprising the sealing band (5) that is further spaced apart from the corresponding end face (15) than the other one (6), or in case that only one sealing band (5) is provided, the second end part (14) comprising said sealing band (5) lies on top of the other first end part (12), wherein the area between the end face (15) of the second end part (14) and the adjacent sealing band (5) of the outer lying second end part (14) defines a junction-free zone providing a tear tab (50), wherein the sealing area (25) comprises a zone (30) providing a strong sealing strength and a weak zone (20) providing a lower sealing strength compared to that of the strong zone (30),
characterised in that
the weakening line/s of said polymer layer (11, 72) start/s from the end face (15) of the second end part (14), extend/s continuously through the junction-free zone and through the whole longitudinal extension of the weak zone (20) and further extend/s into at least a part of said polymer layer adjacent to said sealing zone (25) between the first and second end parts (12, 14).

12. Packaging according to claim 11, characterized in that the weakening line/s (40) extend along the whole border area of the weak zone at the junction zone between the weak (20) and the strong zone (30).

13. Packaging according to claim 11, characterized in that the outer lying second end part (14) is peelable from the subjacent end part (12) within the weak zone (20).

14. Packaging according to claim 11, characterized in that the packaging or wrapping (60) comprises a fin seal (26) showing an inside-inside seal, wherein the inner layer of the film strip (1) directed to the inside of the packaging (60) comprises at least partly the sealing layer (11) and in that the first end part (12) of said film strip (1) is folded back providing a sealing surface made of the sealing layer (11), the second end part (14) of the film strip (1) is sealed onto the folded back part (10) of the first end part (12), wherein the fin seal comprises at least one weak zone (20) having a low sealing strength, wherein the second end part (14) of the film strip (1) extends over the fin seal and the folded back part (10) of the first end part (12) to form the tear tab (50).

15. Packaging according to claim 11, characterized in that the packaging or wrapping (60) comprises a lap seal (27) showing an inside-outside seal, wherein the inner layer of the film strip (1) directed to the inside of the packaging (60) comprises at least partly the sealing layer (11), and in that the second end part (14) of the film strip (1) comprises said sealing layer (11) and is sealed onto the outside of the first end part (12) of the film strip (1), wherein the lap seal (27) comprises at least one weak zone (20) having a low sealing strength, wherein the second end part (14) of the film strip (1) extends over the lap seal (27) to form the tear tab (50).

16. Packaging according to claim 11, characterized in that the packaging (60) has a hermetically sealed inside.

17. A method for manufacturing a packaging according to claim 11 for wrapping a food or pharma product, characterized in that it includes the following steps:
(a) providing a film strip (1) having two opposite end parts (12, 14) according to one of claims 1 to 10,
(b) folding a second end part (14) of the film strip (1) over a first end part (12) of the film strip (1) in a manner that the distance between the outer end face (15) of the second end part (14) to the sealing area (25) is greater than the distance between the outer end face (13) of the first end part (12) to the sealing area (25), and at least a part of the sealing area (25) comprises a weak sealing zone (20) providing a sealing strength that allows the two sealed end parts (12, 14) to be peeled from one another, and that said sealing area (25) comprises the at least one weakening line (40), the weakening line (40) running continuously from the end face (15) of the second end part (14) of the film strip (1) through the whole longitudinal extension of the week zone (20) of the sealing area (25), and into at least a part of the film strip (1) adjacent to said sealing zone (25) in the direction of the first end part (12).
(c) sealing the first and second end parts (12, 14) together wherein the free end face (15) of the second end part (14) of the film strip (1) extends over the sealing area (25) for providing a tear tab (50).

18. A method according to claim 17, wherein the sealing area (25) comprises a zone (30) providing a strong sealing strength and a weak zone (20) providing a lower sealing strength, characterized in that the different sealing strengths of the strong and weak sealing zones (20, 30) is created by the application of different sealing parameters, wherein the sealing zone (30) having the higher sealing strength is made by applying a higher sealing temperature and/or a higher sealing pressure and/or a longer sealing time compared to the sealing parameters used for the sealing zone (20) having weak sealing properties suitable for opening the packaging (60) by peeling the second (14) from the first end part (12) of the film strip (1).

19. A method according to claim 17, wherein the sealing surfaces of the first and/or second end parts (12, 14) are modified to have a different surface textures in the weak zone (20) and in the zone (30) providing a strong sealing strength.
